(19) United States
(12) Patent Application Publication
(10) Pub. No.: US 2017/0171266 A1
(43) Pub. Date: Jun. 15, 2017

(54) METHOD AND ELECTRONIC DEVICE BASED ON ANDROID PLATFORM FOR MULTIMEDIA RESOURCE PLAY

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Xuehui SHI, Beijing (CN); Meng ZHANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/237,151

(22) Filed: Aug. 15, 2016

Related U.S. Application Data
(63) Continuation of application No. PCT/CN2016/089534, filed on Jul. 10, 2016.

(30) Foreign Application Priority Data
Dec. 14, 2015 (CN) 2015109276717

(51) Int. Cl. H04L 29/06; G06F 3/0482; H04N 21/414; H04N 21/472; H04N 21/431

(52) U.S. Cl. CPC H04L 65/4069; H04L 65/60; H04N 21/47217; H04N 21/4312; H04N 21/41407; G06F 3/0482; H04M 1/72561

(57) ABSTRACT

A method and electronic device based on an Android platform for multimedia resource play are provided, where the method includes: acquiring at least two play requests of a user; acquiring corresponding multimedia resources according to the play requests; and calling a corresponding number of play windows to display the multimedia resources on the same page; which enable a user to watch more content at the same time.

### CROSS-REFERENCE TO RELATED APPLICATIONS

The present application is a continuation of PCT disclosure No. PCT/CN2016/089534 submitted on Jul. 10, 2016, which is based upon and claims priority to Chinese Patent Application No. 201510927671.7, filed with the Chinese Patent Office on Dec. 14, 2015 and entitled “METHOD, APPARATUS AND TERMINAL DEVICE BASED ON ANDROID PLATFORM FOR MULTIMEDIA RESOURCE PLAY”, both of which are incorporated herein by reference in their entireties.

### TECHNICAL FIELD

This disclosure relates to the field of multimedia resource play, and more specifically, to a method and electronic device based on an Android platform for multimedia resource play.

### BACKGROUND

Currently, for a video player based on an Android platform, when a user needs to watch other videos, the user has to reselect the other videos after closing a current play window; if a user hopes to watch multiple videos synchronously, then different players need to be opened synchronously, and multiple videos are displayed by means of multiple pages respectively, and the user needs to watch the videos by means of switching pages back and forth.

### SUMMARY

The present disclosure provides a method and a terminal device based on an Android platform for multimedia resource play, so as to improve watching experience of a user.

According to a first aspect, an embodiment of the present disclosure provides a multimedia resource play method based on an Android platform, where the method includes: acquiring at least two play requests of a user; acquiring corresponding multimedia resources according to the play requests; and calling a corresponding number of play windows to display the multimedia resources on the same page.

According to a second aspect, an embodiment of the disclosure further provides a non-transitory computer storage medium, which stores executable instructions, where the executable instructions are used to execute any of the foregoing multimedia resource play methods based on an Android platform of the disclosure.

According to a third aspect, an embodiment of the disclosure further provides an electronic device, including: at least one processor; and a memory in communication connection with the at least one processor, where the memory stores instructions that can be executed by the at least one processor, and the instructions are executed by the at least one processor, so that the at least one processor can execute any of the foregoing multimedia resource play methods based on an Android platform in the disclosure.

According to the method and the electronic device based on an Android platform for multimedia resource play provided in the embodiments of the present disclosure, on an Android platform, after at least two play requests of a user are acquired, display is performed on the same page by means of multiple play windows. The technical solutions provided by the present disclosure enable a user to watch more contents at the same time.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a flowchart of a multimedia resource play method based on an Android platform according to an embodiment of the present disclosure; and

FIG. 2 is a schematic structural diagram of a multimedia resource play apparatus based on an Android platform according to an embodiment of the present disclosure;

FIG. 3 is a schematic structural diagram of hardware of a device for executing a multimedia play method based on an Android platform provided by an embodiment of the disclosure.

### DETAILED DESCRIPTION

To make the objectives, technical solutions, and advantages of the disclosure clearer, hereinafter, the technical solutions of the disclosure will be clearly and completely described by implementation manners with reference to the accompanying drawings in the embodiments of the disclosure. Apparently, the described embodiments are a part rather than all of the embodiments of the disclosure.

FIG. 1 is a flowchart showing a multimedia resource play method based on an Android platform according to an embodiment of the present disclosure.

With reference to FIG. 1, the multimedia resource play method based on an Android platform in this embodiment of the present disclosure includes the following steps:

In step S110: at least two play requests of a user are acquired.

With an arrival of a digital era, a number of multimedia resources in contact with a user is also becoming increasingly large. To be able to listen to and/or watch more multimedia resources in a limited time, this embodiment provides a method for a user to be able to watch multiple multimedia resources synchronously. The following is described only by an example of watching two multimedia resources synchronously, and a method for watching more than two multimedia resources synchronously shares the same principle. The multimedia resources include but are not limited to audios and/or videos, etc.

As an optional implementation manner of this embodiment, acquiring at least two play requests of a user may include: separately acquiring, on a recommendation page of multimedia resources, click and/or touch operations by the user on at least two multimedia resources; and generating corresponding play requests according to the click and/or touch operations.

As an optional implementation manner of this embodiment, for the click operations, a selection operation is performed by a single-click, and a deselection operation is performed by a double-click.

As an optional implementation manner of this embodiment, for the touch operations, a selection operation is performed by a single-touch, and a deselection operation is performed by a double-touch.

In this embodiment, there may be multiple manners for acquiring at least two play requests of a user; a description is provided with a video recommendation page as an example, and acquiring manners thereof may include but are not limited to:

partitioning is performed on a video recommendation page; for videos in a common partition, a single video is played as being clicked; for videos in a check partition, a video can be selected by a single-click, deselected by a second click, and directly played after being quickly and continuously clicked twice. If after multiple videos are selected by single-click, a play widget is clicked, then at least two corresponding play requests are acquired.

Or, a multiple-choice button can be provided on any video display area of a video recommendation page for a user to select after click; after the multiple-choice button corresponding to multiple videos is clicked, a play widget is clicked, then at least two corresponding play requests are acquired.

For example, a description is provided only by an example of multimedia resources as videos. A video recommendation page of a video APP includes a common partition and a check partition, where the common partition is a television drama special partition, including but not limited to recommendation information of Nirvana in Fire and/or recommendation information of television dramas such as The Legend of Miyue, etc.; the check partition is a movie special partition, including but not limited to recommendation information of movies such as Goodbye Mr. Loser, Flying Years, and/or Crusoe, etc.; a play widget is further provided on the video recommendation page; the play widget can be located at a bottom part of the video recommendation page, and also can be located at a bottom part of the check partition; when a user clicks or touches recommendation information in the common partition, a page of details of a corresponding television drama is jumped to; when a user clicks or touches recommendation information in the check partition, an area where the selected recommendation information is located is highlighted or changes in chrominance, or an identifier displayed on a page of the selected recommendation information changes from ⋄ to ♦ after finishing selection, the user clicks or touches the play widget, and a system generates play requests corresponding to the selected videos (multimedia resources).

In step S120: corresponding multimedia resources are acquired according to the play requests.

In this embodiment, for example, a first play request corresponding to a first multimedia resource and a second play request corresponding to a second multimedia resource can be acquired separately; the first play request and the second play request are sent to a multimedia resource server, and the first multimedia resource and the second multimedia resource pushed by the multimedia resource server are received.

In step S110, for example, the user clicks the play widget after selecting recommendation information of Goodbye Mr. Loser and Flying Years in the check partition; in this embodiment, the first multimedia resource is a video resource corresponding to Goodbye Mr. Loser, and the second multimedia resource is a video resource corresponding to Flying Years; the system generates the first play request that requests for Goodbye Mr. Loser, and the second play request that requests for Flying Years, and sends the first play request and the second play request to a video server, and creates a first play window thread and a second play window thread according to information of the first multimedia resource and the second multimedia resource fed back by the video server; the first play window thread downloads the first multimedia resource, and the second play window thread parallel downloads the second multimedia resource (that is, acquiring the first multimedia resource and the second multimedia resource).

In step S130: a corresponding number of play windows are called to display the multimedia resources on the same page.

As an optional implementation manner of this embodiment, the corresponding number of play windows are evenly distributed on the same page.

After the corresponding multimedia resources are acquired, a background performs parallel decoding, and synchronously calls a corresponding number of play windows to separately play the corresponding videos. For example, the user clicks two videos to play synchronous, and then after resources of the two videos are loaded, two play windows are called to synchronously play the resources of the two videos on the same page. Preferably, the two play windows are evenly distributed; for example, each occupies half in an up-to-down manner or half in a left-to-right manner of the same page; a distribution principle of other quantities of play windows is the same, and the play windows are evenly distributed in an up-to-down manner or in a left-to-right manner on the same page.

For example, the first play window and the second play window are synchronously called to display, to the user, on a video display page, a downloaded part of the first multimedia resource and the second multimedia resource.

According to the multimedia resource play method based on an Android platform provided in this embodiment of the present disclosure, on an Android platform, after at least two play requests of a user are acquired, display is performed on the same page by means of multiple play windows. The technical solutions provided by the present disclosure enable a user to watch more contents at the same time conveniently and efficiently, thereby improving watching experience of the user.

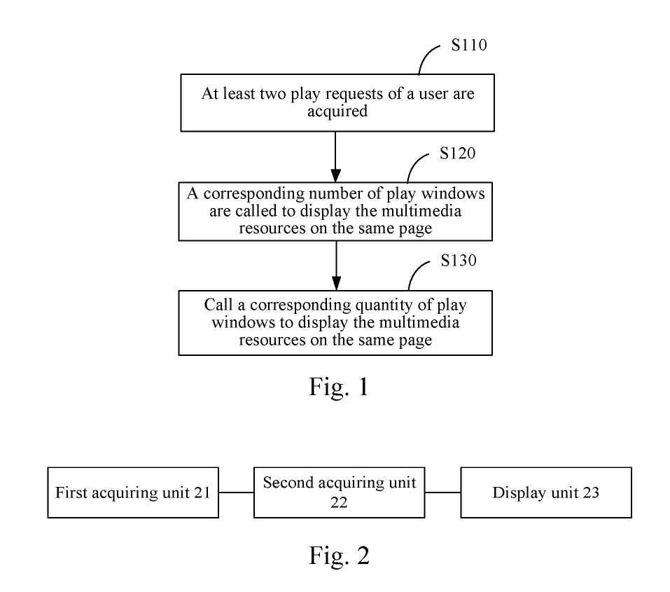

FIG. 2 is a schematic structural diagram showing a multimedia resource play apparatus based on an Android platform according to an embodiment of the present disclosure.

With reference to FIG. 2, in this embodiment, the apparatus is configured to execute various steps of the multimedia resource play method based on an Android platform in Embodiment 1. In this embodiment, the multimedia resource play apparatus based on an Android platform includes a first acquiring unit 21, a second acquiring unit 22, and a display unit 23.

The first acquiring unit 21 acquires at least two play requests of a user.

As an optional implementation manner of this embodiment, the first acquiring unit may include an acquiring subunit and a generation subunit.

The acquiring subunit (not shown in the figure) separately acquires, on a recommendation page of multimedia resources, click operations by a user on at least two multimedia resources.

In this embodiment, there may be multiple manners for acquiring at least two play requests of a user; a description is provided with a video recommendation page as an example, and acquiring manners thereof may include but are not limited to:

partitioning is performed on a video recommendation page; for videos in a common partition, a single video is played as being clicked; for videos in a check partition, a video can be selected by a single-click, de-selected by a second click, and is directly played after being quickly and continuously clicked twice. If after multiple videos are selected by single-click, a play widget is clicked, then at least two corresponding play requests are acquired.

Or, a multiple-choice button can be provided on any video display area of a video recommendation page for a user to select after click; after the multiple-choice button corresponding to multiple videos is clicked, a play widget is clicked, then at least two corresponding play requests are acquired.

The generation subunit (not shown in the figure) generates corresponding play requests according to the click operations acquired by the acquiring subunit.

As an optional implementation manner of this embodiment, for the click operations, a selection operation is performed by a single click, and a deselection operation is performed by a double-click.

For example, a description is provided only by an example of multimedia resources as videos. A video recommendation page of a video APP includes a common partition and a check partition, where the common partition is a television drama special partition, including but not limited to recommendation information of Nirvana in Fire and/or recommendation information of television dramas such as The Legend of Miyue, etc.; the check partition is a movie special partition, including but not limited to recommendation information of movies such as Goodbye Mr. Loser, Flying Years, and/or Crusoe, etc.; a play widget is further provided on the video recommendation page; the play widget can be located on a bottom part of the video recommendation page, and also can be located at a bottom part of the check partition; when a user clicks or touches recommendation information in the common partition, a page of details of a corresponding television drama is jumped to; when a user clicks or touches recommendation information in the check partition, an area where the selected recommendation information is located is highlighted or changes in chrominance, or an identifier displayed on a page of the selected recommendation information changes from ⋄ to ♦; after finishing selection, the user clicks or touches the play widget, and a system generates play requests corresponding to the selected videos (multimedia resources).

The second acquiring unit 22 acquires corresponding multimedia resources according to the play requests acquired by the first acquiring unit.

As an optional implementation manner of this embodiment, the second acquiring unit may include a thread creating subunit and a downloading subunit.

The thread creating subunit (not shown in the figure) creates at least two play window threads according to the play requests acquired by the first acquiring unit.

The downloading subunit (not shown in the figure) separately downloads the corresponding multimedia resources by means of the at least two play window threads created by the thread creating subunit.

For example, the user clicks the play widget after selecting recommendation information of Goodbye Mr. Loser and Flying Years in the check partition; in this embodiment, the first multimedia resource is a video resource corresponding to Goodbye Mr. Loser, and the second multimedia resource is a video resource corresponding to Flying Years; the system generates the first play request that requests for Goodbye Mr. Loser, and the second play request that requests for Flying Years, and sends the first play request and the second play request to a video server, and creates a first play window thread and a second play window thread according to information of the first multimedia resource and the second multimedia resource fed back by the video server; the first play window thread downloads the first multimedia resource, and the second play window thread parallel downloads the second multimedia resource (that is, acquiring the first multimedia resource and the second multimedia resource).

The display unit 23 calls a corresponding number of play windows to display, on the same page, the multimedia resources acquired by the second acquiring unit.

As an optional implementation manner of this embodiment, the display unit may include a decoding subunit and a play subunit.

The decoding subunit (not shown in the figure) decodes the multimedia resources downloaded by the downloading subunit in parallel;

The play subunit (not shown in the figure) synchronously calls the at least two play window threads created by the thread creating subunit to respectively play the corresponding part of the multimedia resources decoded by the decoding subunit.

As an optional implementation manner of this embodiment, the corresponding number of play windows are evenly distributed on the same page.

After the corresponding multimedia resources are acquired, a background performs parallel decoding, and synchronously calls a corresponding number of play windows to separately play the corresponding videos. For example, the user clicks two videos to play synchronous, and then after resources of the two videos are loaded, two play windows are called to synchronously play the resources of the two videos on the same page. Preferably, the two play windows are evenly distributed; for example, each occupies half in an up-to-down manner or half in a left-to-right manner of the same page; a distribution principle of other quantities of play windows is the same, and the play windows are evenly distributed in an up-to-down manner or in a left-to-right manner on the same page.

For example, the first play window and the second play window are synchronously called to display, to the user, on a video display page, a downloaded part of the first multimedia resource and the second multimedia resource.

According to the multimedia resource play apparatus based on an Android platform provided in this embodiment of the present disclosure, on an Android platform, after at least two play requests of a user are acquired, display is performed on the same page by means of multiple play windows. The technical solutions provided by the present disclosure enable a user to watch more contents at the same time conveniently and efficiently, thereby improving watching experience of the user.

An embodiment of the disclosure provides a non-transitory computer storage medium, which stores executable instruction, where the executable instruction can execute the multimedia resource play method based on an Android platform of any of the foregoing method embodiments of the disclosure.

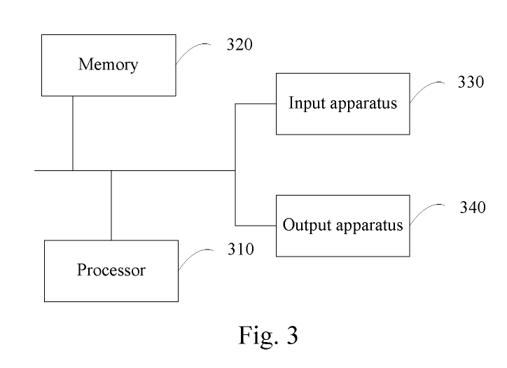

FIG. 3 is a schematic structural diagram of hardware of a device for executing a multimedia resource play method based on an Android platform provided by an embodiment of the disclosure. As shown in FIG. 3, the device includes:

one or more processors 310 and a memory 320, with one processor 310 as an example in FIG. 3.

A device for executing the multimedia resource play method based on an Android platform may further include: an input apparatus 330 and an output apparatus 340.

The processor 310, the memory 320, the input apparatus 330, and the output apparatus 340 can be connected by means of a bus or in other manners, with a connection by means of a bus as an example in FIG. 3.

As a non-transitory computer readable storage medium, the memory 320 can be used to store non-transitory software programs, non-transitory computer executable programs and modules, for example, a program instruction/module corresponding to the multimedia resource play method based on an Android platform in the embodiments of the disclosure (for example, a first acquiring unit 21, a second acquiring unit 22, and a display unit 23 shown in FIG. 2). The processor 310 executes various functional applications and data processing of the server, that is, implements the multimedia resource play method based on an Android platform of the foregoing method embodiments, by running the non-transitory software programs, instructions, and modules stored in the memory 320.

The memory 320 may include a program storage area and a data storage area, where the program storage area may store an operating system and at least one disclosure needed by function; the data storage area may store data created by use of the multimedia resource play apparatus based on an Android platform, and the like. In addition, the memory 320 may include a high-speed random access memory, and also may include a non-transitory memory, such as at least one disk storage device, flash storage device, or other non-transitory solid-state storage devices. In some embodiments, the memory 320 optionally includes memories remotely disposed with respect to the processor 310, and the remote memories may be connected, via a network, to the multimedia resource play apparatus based on an Android platform. Examples of the foregoing network include but are not limited to: the Internet, an intranet, a local area network, a mobile communications network, and a combination thereof.

The input apparatus 330 can receive entered digit or character information, and generate key signal inputs relevant to user setting and functional control of the multimedia resource play apparatus based on an Android platform. The output apparatus 340 may include a display device, for example, a display screen, etc.

The one or more modules are stored in the memory 320, and execute the multimedia resource play method based on an Android platform in any one of the foregoing method embodiments when being executed by the one or more processors 310.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1. A multimedia resource play method based on an Android platform, applied in an electronic device, wherein the method comprises:
acquiring at least two play requests of a user;
acquiring corresponding multimedia resources according to the play requests; and
calling a corresponding number of play windows to display the multimedia resources on the same page.

2. The method according to claim 1, wherein the acquiring at least two play requests of a user comprises:
separately acquiring, on a recommendation page of multimedia resources, click operations by the user on at least two multimedia resources; and
generating corresponding play requests according to the click operations.

3. The method according to claim 2, wherein for the click operations, a selection operation is performed by a single-click, and a deselection operation is performed by a double-click.

4. The method according to claim 1, wherein the acquiring corresponding multimedia resources according to the play requests comprises:
creating at least two play window threads according to the play requests; and
separately downloading corresponding multimedia resources by means of the at least two play window threads.

5. The method according to claim 4, wherein the calling a corresponding number of play windows to display the multimedia resources on the same page comprises:
decoding the downloaded multimedia resources in parallel; and
synchronously calling the at least two play window threads to respectively play the corresponding decoded part of the multimedia resources.

6. A non-transitory computer storage medium storing executable instructions that, when executed by an electronic device, cause the electronic device to:
acquire at least two play requests of a user;
acquire corresponding multimedia resources according to the play requests; and
call a corresponding number of play windows to display, the multimedia resources on the same page.

7. The non-transitory computer storage medium according to claim 6, wherein the instructions to acquire at least two play requests of a user cause the electronic device to:
separately acquire, on a recommendation page of multimedia resources, click operations by the user on at least two multimedia resources; and
generate corresponding play requests according to the click operations.

8. The non-transitory computer storage medium according to claim 7, wherein for the click operations, a selection operation is performed by a single-click, and a deselection operation is performed by a double-click.

9. The non-transitory computer storage medium according to claim 6, wherein the instructions to acquire corresponding multimedia resources according to the play requests cause the electronic device to:
create at least two play window threads according to the play requests; and
separately download corresponding multimedia resources by means of the at least two play window threads.

10. The non-transitory computer storage medium according to claim 9, wherein the instructions to call a corresponding number of play windows to display the multimedia resources on the same page cause the electronic device to:
decode the downloaded multimedia resources in parallel; and
synchronously call the at least two play window threads to respectively play the corresponding decoded part of the multimedia resources.

11. (canceled)

12. An electronic device comprising:
at least one processor; and
a memory in communication connection with the at least one processor and for storing instructions executable by the at least one processor;
wherein the memory stores instructions that can be executed by the at least one processor, wherein the execution of the instructions is executed by the at least one processor, causes the at least one processor to:
acquire at least two play requests of a user;
acquire corresponding multimedia resources according to the play requests; and
call a corresponding number of play windows to display the multimedia resources on the same page.

13. The electronic device according to claim 12, wherein the execution of the instructions to acquire at least two play requests of a user causes the at least one processor to:
separately acquire, on a recommendation page of multimedia resources, click operations by the user on at least two multimedia resources; and
generate corresponding play requests according to the click operations.

14. The electronic device according to claim 13, wherein for the click operations, a selection operation is performed by a single-click, and a deselection operation is performed by a double-click.

15. The electronic device according to claim 12, wherein the execution of the instructions to acquire corresponding multimedia resources according to the play requests causes the at least one processor to:
create at least two play window threads according to the play requests; and
separately download corresponding multimedia resources by means of the at least two play window threads.

16. The electronic device according to claim 15, wherein the calling a corresponding number of play windows to display the multimedia resources on the same page comprises:
decoding the downloaded multimedia resources in parallel; and
synchronously calling the at least two play window threads to respectively play the corresponding decoded part of the multimedia resources.
